(19) United States
(12) Patent Application Publication
(10) Pub. No.: US 2020/0283108 A1
(43) Pub. Date: Sep. 10, 2020

(54) Arrangement for Displaying the Airflow Conditions Around the Sails and the Procedure for its Application

(71) Applicant: Bela Zagyva, Budapest (HU)

(72) Inventor: Bela Zagyva, Budapest (HU)

(21) Appl. No.: 16/645,263

(22) PCT Filed: Aug. 1, 2018
(86) PCT No.: PCT/IB2018/055771

§ 371 Date: Mar. 6, 2020

(30) Foreign Application Priority Data
Sep. 6, 2017 (HU) P1700370

(51) Int. Cl. B63H 9/06; B63B 49/00; G01P 13/02; G01P 15/105

(52) U.S. Cl. CPC B63H 9/06; G01P 15/105; G01P 13/025; B63B 49/00

(57) ABSTRACT

The subject of the invention is an arrangement for displaying the airflow conditions around the sails, including a wind sensing device (200a, 200b, 200c, 450), a central device (600) and a signal transmission device (300a, 300b), and at least one of the wind sensing devices (200a, 200c, 450) being a built-in wind sensor device fixed on the sail (200a, 200b, 200c). It is characterized in that the built-in wind sensor device (200a, 200b, 200c) is connected to the central device (600) and contains electronic units. The process for the application of the arrangement is also a subject of this invention.

The present invention relates to an arrangement for displaying the airflow conditions around the sails, including a wind sensor device, a central device and a signal transmission device, and at least one of the wind sensor devices is a built-in wind sensor device mounted on the sail. The subject of the invention is also the procedure to observe the airflow conditions around the sails, with the built-in wind sensor devices fixed on the sail, to describe the flow with the measurement data, and based on the measurement data to support the crew in navigating the boat.

In order to achieve the optimal sailing performance (speed, angle to the wind, safe sailing, etc.) the sails of the boat should be set such a way, that the sum vector of forces arising on the sails always has the proper direction, point of application and size. This vector is determined by the 3D shape of sails by the given (apparent) wind direction and force. The shape of the sails is set by the crew using the rig and ropes of the boat, considering the sailing environment conditions. Instruments normally used on sailboats give sufficient information about the boat speed, direction and speed of the apparent wind (as the sum of real wind and leading wind) and the rudder angle. However, the spatial form of the sails and its deviation from the optimal shape can be estimated only as a rule of thumb and based on the actual sailing performance by the sailing crew. Telltales (thin yarns or tapes fixed on proper points of sail) are simple and cheap aids for trimming of sails. As long as there is an undisturbed flow along the sail, the telltales will stream horizontally aft, pointing towards the stern, without fluttering. When the airflow is disturbed due to wrong trim, the telltales at that location will start to flutter.

In case the reliable and frequent monitoring of telltales can be provided, a system can be set up for processing such data, supporting the sailing crew in optimal setting of sails and optimizing the sailing performance of the boat.

With the current techniques the following solutions are known.

The Dutch patent document with publication number NL 8803205 introduces the traditionally used, clearly “mechanical” windvane.

The British GB 2105846 B patent document introduces an optical measurement arrangement to sense the distortion of a bluff body in fluid flow. By analysing the interferometric image of the beam of optical radiation reflected by the internal body wall, the distortion can be sensed.

In the US patent document with publication number U.S. Pat. No. 3,654,807 from 1972, D. S. Deskey applies thermistor sensors placed on both sides of the sail. The wind flow along the sensors cool the sensors in the function of airflow speed and characteristics, so the change of the detected temperature difference indicates the change in wind angle too, and the system provides information for the crew accordingly. The crew should give manual input on the control panel about the actual sailing maneuver, this makes the system operation complicated. Other conditions that impacts the sensor temperature, like light/shadow conditions, rain etc. can cause inaccuracy.

The patent document of J. V. Man, from the USA, with the publication number U.S. Pat. No. 3,763,703 A, from 1973 is based on sensing the air pressure on both sides of the sail. Leading flexible tubes from aneroid barometers to specific point of the sails, the air pressure at these points can be measured, and information can be gained to adjust sail settings. The measured data does not provide information about the real airflow conditions, e.g. turbulences. More measurement points would be necessary, but this would make complicated the deployment and operation of the system.

In 1999, in the USA patent document with publication number U.S. Pat. No. 5,877,415 A, L. Kruse patented a solution which detects the vertical angle of the telltales, and provides feedback for the crew about it. The measurement of the angle is performed by rotation sensors at the fixing point of the telltales. This solution can not detect the fluttering of telltales, therefore it can provide only a partial support for sail adjustments. Essentially the same solution is described in the patent of J. Leboff in 2014, from the USA, under publication number US 20140260593 A1, with the same limitations.

The international patent number WO 2009066013 A1 submitted by D. Voisin et al in 2010 describes a solution, where the telltale is connected to the sail by a flexible tape. The tape is deformed according to the movement of the telltale, and force gauges deployed on the tape convert this deformation to electronic signals. The status of the telltale can be determined by these provided signals. This solution is not able to track the accurate status of the telltale, as the deformation of the tape is limited by the sensors fixed on the tape, so this way mainly the direction of the telltale can be determined. This solution can not accurately measure the fluttering and doubling back of the telltale.

The international patent number WO 2011110602 A1 WP of S. Rakoczy and T. McGuinness in 2011 describes a solution where the telltale is placed on an electronic unit fixed on the sail. 4 transceiver/receiver infrared blocks are placed at different heights in front of the telltale. Light impulses frequently transmitted by the IR block are reflected by the telltale, therefore the fluttering or steady streaming state of the telltale can be determined. The system is mentioned in the invention only as a sail entry monitoring solution. Should the solution be used for mainsail mid telltale, more IR blocks would be necessary, because in this case the telltales are moving in much wider angle range. However, this would make the size of the unit much bigger. The applicability of the solution is heavily impacted by weather conditions, e.g. direct sunlight or heavy rain. The IR blocks should be kept clean continuously, or at least should be cleaned regularly. Due to the method of operation the electronic unit has a minimal size (80×40×8 mm according to the patent text). This can negatively influence the performance and operation of the sails in case of several telltales.

The aim of the invention is to eliminate the problems of the previous solutions and to create such device and the related procedure, which can make the sail trimming more precise and effective by automatic monitoring of the status of telltales mounted on the sails of the boat, furthermore can provide support to making the necessary adjustments while providing continuous information.

The invention is based on the recognition that if the arrangement is carried out according to claim 1, then a more advantageous invention will be created.

Such recognition allows us to free the crew of the boat from continuous watching of the sails, so the busy, tired or less experienced crew can achieve better sailing performance. Part of the invention is the recognition, that by applying purely electronic units under unfavourable environmental conditions (bad weather, low visibility) that can generally arise during sailing, we can achieve the above specified requirements. Furthermore, we realized that by digitizing units and devices, we can achieve much more sensitive and accurate results compared to visual observation, not to mention that we can do it faster, and thus evaluation becomes more efficient with the help of information technology, using electronic measuring instruments.

According to the objective set, the most general embodiment of the invention can be realised as specified in claim 1. The most general form of the application procedure is described in the procedure main claim. Various modes of the invention embodiments are described in the sub claims.

The feature of the invention is that the built-in wind sensor device contains electronic units and is connected to the central device. Data connection between units can have many ways, the signal transmitter devices can be for example galvanic connection, optic cable, wireless data connection (e.g. Wi-Fi), or any possible combination of these. The communication protocol can be NMEA 0183 or NMEA 2000 used in marine industry or any other standardized or proprietary protocol.

The invention can be used to log the workload of sails, as well. The controller device on the sail can store the measured parameters, that can be read/acquired by the manufacturer afterwards. These data can be used for product support and development.

Another embodiment can be that the controller device is placed between the built-in wind sensor device and the central device, and the devices are connected by the transmitter. The controller device is then dedicated to the control, create, transmit and process the built-in wind sensor devices. Specific system components can be functionally merged or detached, for example the central device can take over the function of controllers, and for example the digital signal processing can be performed by the dedicated units integrated in the built-in wind sensor devices. In a preferred embodiment the controller devices are directly connected (e.g. via Bluetooth or Wi-Fi) to external, general-purpose smart devices that trigger the central device (for example, smartphones, tablets, desktop or portable personal computers).

Another embodiment can be when the built-in wind sensor device contains a moving unit, an accelerometer unit, a transmitter unit, a controller unit and a converter unit, and at least one of the accelerometer units is fixed on the moving unit. For example, taking advantage of the size of the micro-electromechanical sensing devices (MEMS), the current state of the flow can be observed by means of a device mounted on the moving unit. By processing actual 3D acceleration data the degree of fluttering of the moving unit can be determined, while the position related to the geomagnetic field unequivocally indicates the doubling back. The accelerometer measures the actual 3D acceleration values, therefore it senses the direction of Earth gravitation, so the angle of telltale can be calculated. It also senses the occurring acceleration in any directions so the fluttering degree and direction of the telltale can be calculated. For the sake of higher accuracy and reliability a reference accelerometer can be fixed on or near the controller unit, i.e. on the sail. Errors caused by tilt of the boat and the waves can be eliminated by comparison of measurements done by the two accelerometer units. In case the controller unit equipped by accelerometer unit is fixed in itself on the edge of the sail, the sensor can detect the luffing/fluttering of the sail e.g. on spinnaker or gennaker too.

Another embodiment includes an external wind sensor device, a rudder sensor device and a graphical user interface (GUI) connected to the central device. The external wind sensor device may include any membrane, pressure gauge or flow rate measuring device, but it may also be identical with the built-in wind sensor devices, however, not mounted on a sail but on the tip of the mast. The rudder sensor device is preferably a digital incremental rotation detector or any other shaft rotation encoding device, but can also be a linear (e.g., laser) telemeter, observing the distance of a point of a rudder to the hull. The GUI is preferably implemented by an electronic screen, through which direct graphical and text guidance can be given on how to make the settings.

In another embodiment the built-in wind sensor device comprises a magnetic sensor unit and a magnet, and at least one of the magnetic sensor units is located on the moving unit.

The feature of the application is, that the built-in wind sensor device is connected to the central device, and the built-in wind sensor device uses an electric unit. During the application of the invention, the workload of the sails, the measured data can be easily logged by recording the data series provided by the electronic devices on electronic data storage equipment. The data storage device can be integrated into the central device or another device of the arrangement or can be connected as a separate device to the arrangement.

Another feature of the application can be, that the electronic signals of the built-in wind sensor device are processed and evaluated before the central device, and forward such data to the central device. The acceleration or magnetic field force signals are appropriately processed by the fast Fourier-transformation (Fast Fourier Transformation—FFT), or could be processed directly. For processing the high amount of information, artificial intelligence, e.g. neural network can be applied as well.

The application may also be functioning by measuring the acceleration values at the points of the built-in wind sensor device moving and stationary, compared to the sail, and calculating the flow around the sail with the calculated acceleration difference. On the acceleration values, before calculating the difference, we preferably use the low pass filter, or average them for certain sampling time periods (so called windows). When measuring 3D acceleration values, the motion of the moving unit of the built-in wind sensor device can already be characterized by the acceleration values measured at the primary, i.e. the moving active point and the reference, i.e. the measurement point on the sail, from which for example by numeric integration the position can also be calculated.

Another form of application can be when the characteristics of the air flow far from the sail and unforced and also the angle of the rudder are measured.

Another form of application is when the deviation from the geomagnetic direction is measured at the moving point of the built-in wind sensor device compared to the sail, and also measure the deviation from the geomagnetic direction at the point of the built-in wind sensor device stationary compared to the sail.

The invention will now be described in more detail with reference to the embodiment examples, using figures.

The figures describe the followings:

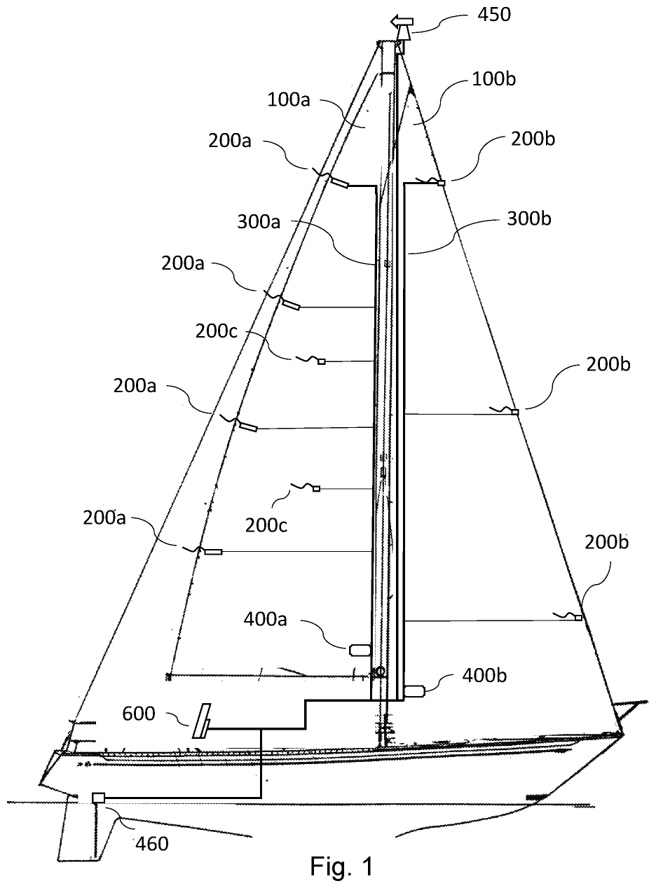

FIG. 1 shows a typical embodiment of the arrangement,

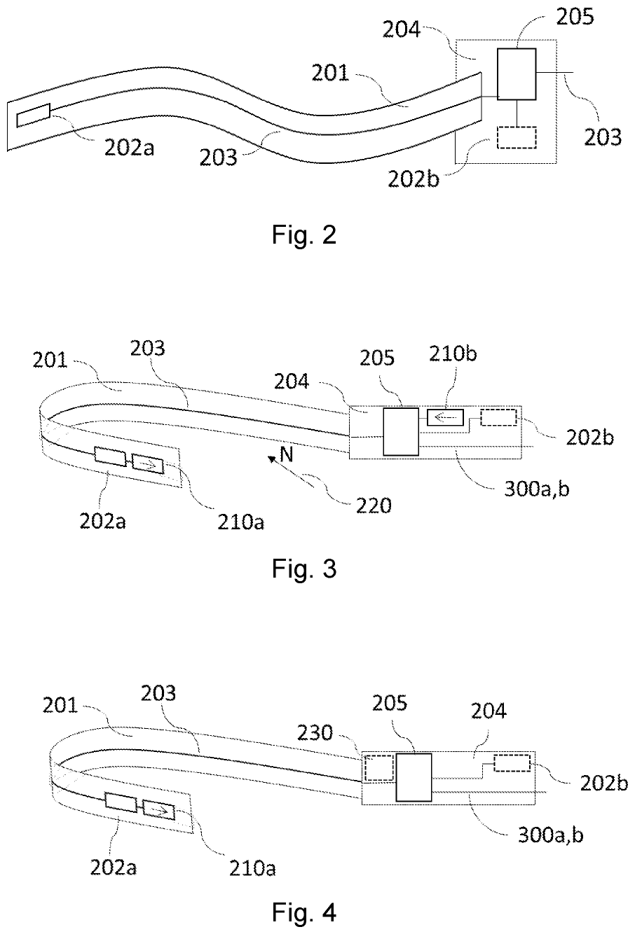

FIG. 2 shows a typical embodiment of the wind sensor device, while

FIG. 3 shows another possibly embodiment of the wind sensor device, with magnetic sensor units added,

FIG. 4 shows the preferred embodiment of the magnetic sensor units,

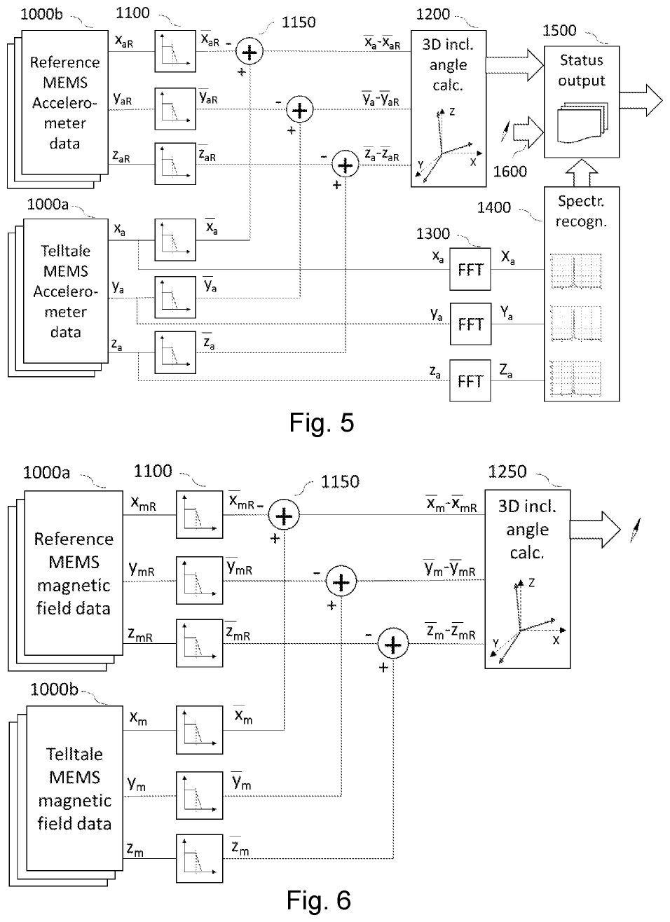

FIG. 5 shows the draft of the typical, digital embodiment of processing the accelerating signals from the wind sensor devices,

FIG. 6 shows a possible embodiment of processing the magnetic sensor signals from the wind sensor devices,

FIG. 7 shows a possible embodiment of GUI,

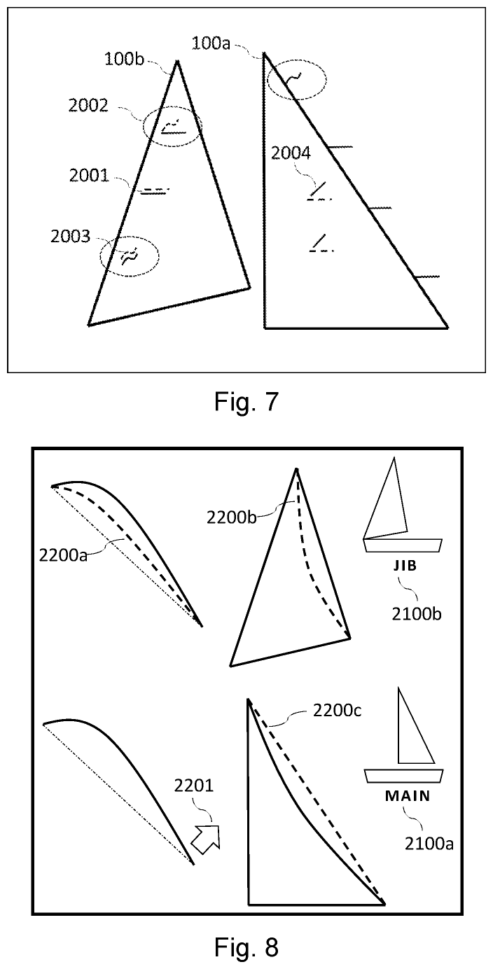

FIG. 8 shows the suggestions and instructions transmitted to the crew via the GUI, and finally

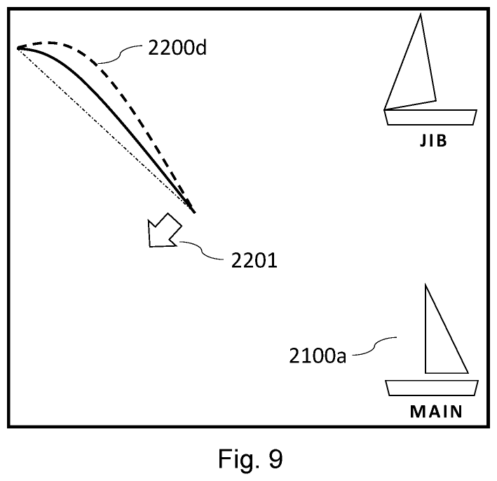

FIG. 9 shows the example of using GUI, in a status not requiring intervention but providing general information.

FIG. 1 gives a draft overview of the arrangement. The 200b built-in wind sensor devices mounted on the 100b jib, the 200a built-in wind sensor devices mounted on the 100a mainsail leech, and the 200c built-in wind sensor devices mounted on the middle of the 100a mainsail are fixed at the usual places of 100a mainsail and 100b jib. The 200a, 200b and 200c built-in sensor devices are connected by flexible and strain resistant wires to 300a and 300b signal transmitters, typically to 100a and 100b cables running along the sails. The 300a and 300b signal transmitters forward the signals from 200a, 200b, 200c, 450 and 460 sensor devices to the 400a and 400b controller devices. 400a and 400b controller devices collect and analyse the direct data from 200a, 200b and 200c built-in wind sensor devices, and they establish the status of the individual 201 moving units (degree and direction of flutter, etc.). The information from 400a and 400b controller devices progresses to 600 central device with display (GUI). The 600 central device represents the control and information unit for the sailing crew, and provides system integration to other external units of the boat. The figure presents 450 external wind direction sensor and 460 rudder sensor, connected to 600 central unit. The 600 central device provides network connection to remote systems (e.g. mobile Internet connection), and connection with other smart devices (e.g. Wi-Fi connection with mobile phones).

FIG. 2 presents the structural set-up of 100b jib and 200b and 100a mainsail mid 200c built-in wind sensor devices. The 202a MEMS acceleration sensor unit is deployed at the end of the 201 moving unit, preferably a flexible tape. The MEMS unit is connected to the sail-mounted 204 controller unit through the 203 signal transmitter unit, a light and flexible cable along the tape. The 201 moving unit itself is fixed to 204 controller unit, i.e. indirectly to 100a and 100b sails. The signals coming from MEMS unit are forwarded by 205 converter unit to the 100a, 100b sail and 400a, 400b controller device, via the 300a, 300b transmitter device. The 202b reference MEMS accelerometer unit in the 204 controller unit provides reference data bout the movement and position of the boat (sail), to eliminate the errors caused by tilt of the boat and the waves.

FIG. 3 illustrates a possible set-up of 200a built-in wind sensor device, performing the function of the 100a mainsail leech telltale, in the state when the air flow makes the telltale double back. The difference between this set-up and FIG. 2 is, that the 204 controller unit takes the function of batten as well, furthermore, at the end of 200a wind sensor device there is the 210a magnetic sensor unit, i.e. a 3D MEMS magnetic field sensor. The 210a magnetic field sensor unit can determine its own direction (and of the 201 moving unit at the same time) related to the 220 geomagnetic direction. A 210b reference magnetic field sensor unit is located on or near the 204 control unit, i.e. on the 100a mainsail entry, in order to eliminate local magnetic field effects and to achieve higher accuracy. The direction of the 201 moving unit can be accurately determined by the comparison of the measured values coming from the two, 210a and 210b magnetic field sensor units, including the case if the telltale doubles back because of the airflow.

An other possible set-up of 200a built-in wind sensor device mounted on 100a mainsail leech is shown by FIG. 4. In this set-up 230 magnet, i.e. permanent or electromagnet is mounted on or near 204 controller unit, i.e. on 100a mainsail entry. If based on the signals of 210a magnetic sensor unit, the distance reduction between 230 magnet and moving 210a magnetic field sensor is detected, the conclusion can be drawn that 201 moving unit is doubling back.

FIG. 5 shows how the data provided by 200a, 200b and 200c built-in wind sensor devices are digitally processed by 400a and 400b controller devices. The units described here, representing part of the process, could be implemented as a separate hardware unit or as a software function. 200a, 200b and 200c built-in wind sensor devices transfer the sampled acceleration data along x-y-z axes (3D) to 400a and 400b controller devices, in a specific timeframe, coming from measurements of both the primary 202a accelerometer on the 201 moving unit and the reference 202b accelerometer. From the measurements by the primary 202a accelerometer unit the primary 1000a data series, from the data by the reference 202b accelerometer unit the reference 1000b data series are produces. In order to determine the 3D direction of 201 moving unit, as the first step, the acceleration data measured along axes (x-y-z, x_{R}-y_{R}-z_{R}) (xₐ, yₐ and zₐ based on primary 202a accelerometer unit, x_{aR}, y_{aR}, z_{aR} based on 202b accelerometer unit) are processed by 1100 low pass filter unit. The average acceleration values are provided as the result of the filtering, corresponding with the vector of the Earth gravitation. The 1150 subtracting unit subtracts from the averages of the accelerations along the xₐ, yₐ, zₐ primary axle, from the averages along the reference axle x_{aR}, y_{aR}, z_{aR}, related to the appropriate axles, the 3D angle of the resultant vector provides the position of the 201 moving unit, which is calculated by the 1200 3D angle calculating unit. Periodic functions of time are provided by xₐ, yₐ, zₐ signals in case of 201 moving unit, and the degree and characteristic of fluttering can be determined by the parameters of these functions. For evaluation, the spectrum of the signals (discrete frequency components) serves as the basis. For this purpose 1300 spectrum analysis on the digital data series of the acceleration signals, i.e. FFT shall be performed. The resulting Xₐ, Yₐ, Zₐ discrete spectrums are compared with the pre-stored sample spectrum by 1400 comparison unit, and determines the fluttering characteristics of 201 moving unit based on this comparison. The composite output of 400a and 400b controller devices is provided by 1500 evaluation unit, using the 201 moving units angle and fluttering data. The 1500 evaluation unit receives the doubling back status information from 1600 leech port in case of 200a built-in wind sensor devices, provided by 1250 doubling back calculating unit.

FIG. 6 follows the processing of the signals of the 200a built-in wind sensor device, as leech telltale. The units described here, representing part of the process, could be implemented as a separate hardware unit or as a software function. The signals from primary and reference 210a and 210 by magnetic sensor units placed in 200a built-in wind sensor device can be processed by the liftering and subtracting applied for processing the acceleration signals, thereby recognising the relative position of the two, 210a and 210b magnetic sensor units, i.e. the doubling back. The magnetic field forces along the primary axles (x-y-z, x_{R}-y_{R}-z_{R})xₘ, yₘ, zₘ and the magnetic field forces along axle X_{mR}, y_{mR}, Z_{mR} are averaged by 1100 low pass filter unit, and 1150 subtraction unit calculates the given differences by the angles. 1250 doubling back calculating unit computes angle data, which provides doubling back information to signal input of 1600 leech of 400a and 400b controller devices. In case of the embodiment example using 230 magnet in 200a and 200b built-in wind sensor devices presented on FIG. 4, the simple binary signal from 210a magnetic sensor unit provides information about the doubling back of 201 moving unit, towards 1600 leech signal input.

FIG. 7, as the GUI embodiment, presents the screen where the status of all 200a, 200b and 200c built-in wind sensor devices are displayed directly in symbolic form. The screen displays both the 100b jib and the 100a mainsail. 201 moving units streaming aft due to undisturbed airflow are represented by 2001 horizontal straight lines, the windward one is the continuous line, the leeward (which is on the other side of the sail from the helm) is the dashed line. Telltales that require attention are highlighted by 2002 ellipse shape frames. The fluttering 201 moving unit, as the telltale (due to turbulences) is represented by 2003 curvy line. The setting of the optimum shape of the sail is supported by the fact, that the status of the 201 moving units positioned in the stable airflow are indicated by 2004 straight, oblique symbols.

FIG. 8 shows the embodiment of the GUI, supporting the less experienced crew with direct instructions. Separately for the sails, small 2100a and 2100b sail icons indicate if the symbols next to them apply to 100a mainsail or to 100b jib. In normal case the icons are in green colour, in case of required intervention the colour of 2100a and 2100b sail icon first changes to yellow than red. Blinking 2200a dashed line at 100b jib indicates that depth of the sail profile should be decreased. Similarly blinking 2200 b dashed line shows that leech twist of 100b jib should be increased. Blinking 2201 arrow indicates that the 100a mainsail should be eased, additionally 2200c blinking dashed line shows that 100a main leech twist should be closed.

FIG. 9 presents the embodiment within GUI, displaying a case of required intervention only for one sail. 2200d blinking dashed line indicates the required increase of profile depth of 100b jib, 2201 blinking arrow shows that the jib should be tightened. In this case the 2100a sail icon of the 100a main sail is green, and the nearby field is, as no intervention is necessary.

When applying the invention, it provides the crew with a constant, automatic flow monitoring of the sails according to the desired result and, in accordance with the embodiments shown, provides support to the crew, in real time.

The arrangement and process offers several advantages. As a general advantage, the skipper is provided with continuous and accurate feedback about the sail profile, therefore higher speed can be achieved. Better performance can be achieved at lower wind speed; usage of engine can be avoided resulting in fuel saving and more environment friendly sailing. One advantage of the invention is that it is able to evaluate the real 3D motion of the moving unit, hence the fast and complex changes of airflow can be tracked. Another advantage is, that it is able to display the flow conditions in real time, reliably and at any widely used type of sails. Further advantages of the invention are the followings. Both the sensor devices and the processors in the central and controller devices, processing the data provided by sensors are available on the market in big quantity and at favourable price. The system can be operated reliably in extreme weather conditions and does not require any special maintenance. By processing accurate data coming from the sensor devices, a much more sensitive system can be set up in comparison with the traditional visual observation. The MEMS acceleration sensor provides precise, high resolution, 3D acceleration data. Based on these, even movements of the moving unit invisible to the naked eye can be detected. Timely warning can be provided e.g. in case of accidental gybe (when sailing downwind the mainsail gets hit by a wind shift), such event is responsible for big part of the sailing accidents.

The system can provide early warnings about the necessary changes of sail settings, so they can be implemented with minimal loss of time, therefore higher speed can be achieved. This advantage is realized at both manual and automatic boat control. By this solution the sailboat crew can be relieved from continuous watching of telltales and reliable feedback can be provided in bad weather conditions and low visibility, as well. The system can give input to the autopilot, so in favourable conditions automatic keeping of optimal angle to apparent wind can be provided. Electric winches can be connected as well to the system, so automatic setting of sails can be realized based on data provided by the telltales. Real time monitoring of sail profile in tense conditions is very important in regattas, among different angles of apparent wind and at all types of sails applied. Data provided by the system can be integrated to other sailing support systems well.

The field of application of the invention is the systems for sailing and boat crew support.

Further to the above examples, and within the patent protection, the invention can be realized in other embodiment and manufacturing procedure.

1. An Arrangement for displaying airflow conditions around one or more sails, said arrangement comprising a wind sensor device, a central device and a signal transmission device;
wherein at least one of the wind sensing devices being a built-in wind sensor device fixed on the sale, and wherein the built-in wind sensor device is connected to the central device and further comprises a moving unit, at least one accelerometer unit, a signal transmitter unit, a controller unit, and a signal converter unit,
characterized in that at least one of the accelerometer units is located in the moving unit.

2. The arrangement according to claim 1, further characterized in that a controller device is located between the built-in wind sensor device and the central device, and wherein the wind sensor device and the central device are connected by the signal transmitter device.

3. (canceled)

4. The arrangement according to claim 1, in which the arrangement further comprises an external wind sensor device, a rudder sensor device and a graphic user interface; and in which the external wind sensor device, the rudder sensor device, and the graphic user interface are all connected to the central device.

5. The arrangement according to claim 1 further characterized in that the wind sensor device contains at least one magnetic sensor unit and/or magnet, and at least one of the magnetic sensor units is located on the moving unit.

6. Procedure for applying the arrangement for displaying flow of air around one or more sails wherein;
the flow around the sail is observed with the built-in wind sensor device mounted on the sail;
the flow of air is described by the measured data said measured data being based on the measurement data and being displayed in a manner usable for navigation purposes and in which the measurement data is calculated to reflect the difference in acceleration of the flow of air around the sail;
wherein the sensor device is connected to the central device; and
further characterized in that a plurality of acceleration values are measured at a moving point of the wind sensor device and at a stationary point of the wind sensor device relative to the sail.

7. The procedure according to claim 6 further characterized in that the measured data from the built-in wind sensor device electronic is processed and evaluated before said measured data is forwarded to the central device and then processed and evaluated measured data is forwarded to the central device (600).

8. (canceled)

9. The procedure according to claim 6, further characterized in that characteristics of the flow of air far from the sail and the angle of the rudder are measured.

10. The procedure according to claim 6, deviation from the geomagnetic direction (220) is measured at the point of the built-in wind sensor device (200a, 200b, 200c) moving and at the point stationary compared to the sail.

11. The claim according to claim 1, further characterized in that the moving unit is fixed to the controller unit: and a reference accelerometer is fixed on or near the controller unit.
